(19) United States
(12) Patent Application Publication
(10) Pub. No.: US 2020/0167321 A1
(43) Pub. Date: May 28, 2020

(54) MANAGEMENT OF ELECTRONIC DATA

(71) Applicant: The Bureau of National Affairs, Inc., Arlington, VA (US)

(72) Inventors: Ryan Sheehan, Arlington, VA (US); Kenneth B. Crutchfield, Alexandria, VA (US); Diane Tinney, Alexandria, VA (US); Mark Baker, Oak Hill, VA (US); Rajesh Vantipalli, Ashburn, VA (US)

(73) Assignee: The Bureau of National Affairs, Inc., Arlington, VA (US)

(21) Appl. No.: 16/202,910

(22) Filed: Nov. 28, 2018

(51) Int. Cl. G06F 16/18; H04L 29/06; G06F 21/62; G06F 17/24

(52) U.S. Cl. CPC G06F 16/1873; G06F 17/246; G06F 21/6218; H04L 63/102

(57) ABSTRACT

Systems and methods for managing electronic data are provided. An end user is associated with a level of access. Values of cells of a spreadsheet are linked to external source data. The external source data are selected by the end user from a set of available external source data according to the level of access. A version history of the spreadsheet is maintained. The spreadsheet is caused to be presented with the linked values and the version history to the end user according to the level of access.

### TECHNICAL FIELD

The present invention relates generally to electronic data management and analysis, and more particularly to an improved system for managing and analyzing electronic data in a spreadsheet.

### BACKGROUND OF THE INVENTION

With the advancement of computer technology, massive amounts of electronic data is being collected and maintained. Such electronic data is often organized and managed in electronic documents to perform various data analysis tasks. However, conventional systems for managing electronic data have several inherent drawbacks that may result in significant human error in performing important data analysis tasks.

As an example, spreadsheets are traditionally used by accounting professionals to organize and manage electronic data and to perform a wide range of functions, such as data collection, data analysis, and workflow tracking. Conventional spreadsheets are popular because they are relatively easy to use, provide for a wide range of calculation possibilities, and are flexible enough to allow accounting professionals to perform many necessary functions. However, conventional spreadsheets have a number of drawbacks. For example, many conventional spreadsheets rely on manual data entry and formula creation, which may result in user error. Many conventional spreadsheets also lack automatic tracking of changes and version history, making it difficult to identify and undo errors.

While some conventional spreadsheets have the ability to protect cells and set cell editing permissions, specific permission groups must be setup outside of the spreadsheet program and each spreadsheet must be given these permissions. Further, while some conventional spreadsheets have a track changes mode, the track changes mode cannot be enabled at the same time a sheet has protections. Some conventional spreadsheets may also be configured with add-ins that allow data to be transferred to and from the spreadsheet, however this process often requires a manual push or pull of data, providing the opportunity for data in spreadsheet to be out of sync with data in other systems.

### SUMMARY

In accordance with one or more embodiments, systems and methods for managing electronic data are provided. The electronic data is organized into a spreadsheet accessed by an end user. The end user interacts with the spreadsheet to link values of cells of the spreadsheet to external source data. The external source data is selected by the end user from a set of available external source data according to a level of access associated with the end user. Changes made to the spreadsheet are tracked to maintain a version history of the spreadsheet. The spreadsheet is presented with the linked values and the version history on a display device according to the level of access associated with an end user.

In accordance with one embodiment, the level of access is for accessing the spreadsheet. The level of access defines access to a workbook of the spreadsheet, a tab of the workbook, a group of cells of the tab, and/or a particular cell of the tab for the end user.

In accordance with one embodiment, the level of access is for accessing a supporting document. The end user may interact with the spreadsheet to associate the spreadsheet with the supporting document according to the level of access. The spreadsheet may be associated with the supporting document by associating entirety workbook of the spreadsheet, a tab of the workbook, a group of cells of the tab, and/or a particular cell of the tab with the supporting document. The supporting document is selected from a set of available supporting documents that the end user is authorized to access according to the level of access.

In accordance with one embodiment, the value of the cell of the spreadsheet may be linked to the external source data by selecting the external source data from the set of available eternal source data that the end user is authorized to access according to the level of access. The external source data may include a cell of another spreadsheet and/or data generated by an application.

In accordance with one embodiment, the spreadsheet is also caused to be presented with particular changes associated with a version of the spreadsheet to the end user. The particular changes are changes that the end user is authorized to view according to the level of access.

In accordance with one embodiment, the spreadsheet is stored in an encrypted database.

In accordance with one or more embodiments, a non-transitory computer readable medium stores data associated with cells of a spreadsheet, links associating values of particular cells of the spreadsheet with external source data, and a version history of the spreadsheet. The external source data is selected by an end user from a set of available external source data according to a level of access associated with the end user. The data, the links, and the version history facilitate presentation of the spreadsheet to the end user according to the level of access.

These and other advantages of the invention will be apparent to those of ordinary skill in the art by reference to the following detailed description and the accompanying drawings.

### BRIEF DESCRIPTION OF THE DRAWINGS

FIG. 1 shows a high-level diagram of a communications system, in accordance with one embodiment;

FIG. 2 shows a method for managing an analyzing electronic data, in accordance with one embodiment;

FIG. 3 shows an illustrative spreadsheet for managing and analyzing data, in accordance with one embodiment;

FIG. 4A shows a user interface for associating a level of access with an end user for accessing a spreadsheet, in accordance with one embodiment;

FIG. 4B shows a spreadsheet presented according to a level of access for an end user, in accordance with one embodiment;

FIG. 5A shows a user interface for uploading supporting documents, in accordance with one embodiment;

FIG. 5B shows a user interface for associating a level of access with an end user for accessing supporting documents, in accordance with one embodiment;

FIG. 6A shows a user interface for linking a value of a cell of a spreadsheet to external source data, in accordance with one embodiment;

FIG. 6B shows a window in which an end user may select a supporting document, in accordance with one embodiment;

FIG. 6C shows a window in which an end user may select external source data from a supporting document to link to a cell, in accordance with one embodiment;

FIG. 6D shows a window confirming a link between a cell and another cell in a different spreadsheet, in accordance with one embodiment;

FIG. 6E shows a link between a cell of a spreadsheet and a cell of a different spreadsheet, in accordance with one embodiment;

FIG. 7 shows a workflow for linking a cell to external source data that is named, in accordance with one embodiment;

FIG. 8A shows a spreadsheet linked with supporting documents, in accordance with one embodiment;

FIG. 8B shows a user interface for associating a cell of a spreadsheet with supporting documents, in accordance with one embodiment;

FIG. 9 shows a user interface showing a version history of a spreadsheet, in accordance with one embodiment;

FIG. 10 shows a user interface for viewing access history of documents, in accordance with one embodiment; and

FIG. 11 shows a high-level block diagram of a computer, in accordance with one embodiment.

### DETAILED DESCRIPTION

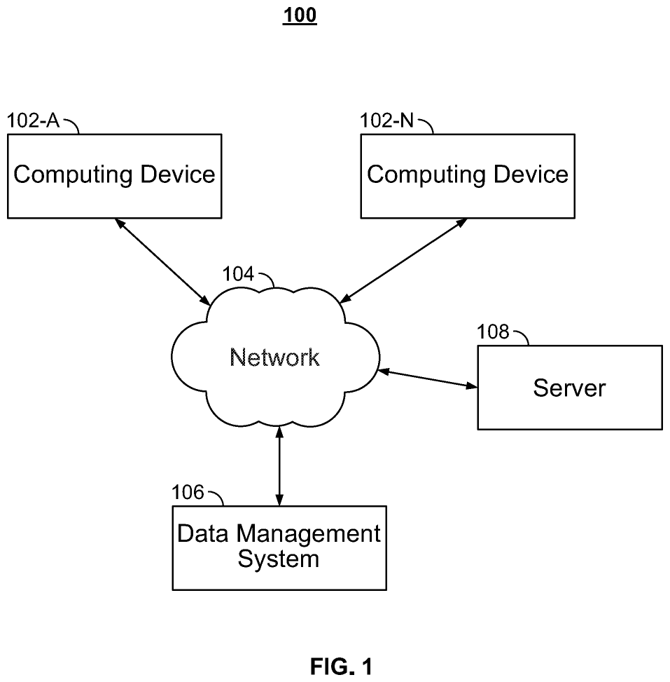

FIG. 1 shows a high-level diagram of a communications system 100, in accordance with one or more embodiments. Communications system 100 includes computing devices 102-A through 102-N (collectively referred to as computing devices 102). Computing devices 102 may comprise any type of computing device, such as, e.g., a computer, a tablet, or a mobile device. Computing devices 102 are operated by end users for communicating via network 104. Network 104 may include any type of network or combinations of different types of networks, and may be implemented in a wired and/or a wireless configuration. For example, network 104 may include one or more of the Internet, an intranet, a local area network (LAN), a wide area network (WAN), a cellular communications network, etc.

End users of computing devices 102 may communicate via network 104 for interacting with a data management system 106 for managing and analyzing electronic data. End users may interact with data management system 106 via an interface of a web browser executing on computing device 102, an application executing on computing device 102, an app executing on computing device 102, or any other suitable interface for interacting with data management system 106. In one example, end users of computing devices 102 may interact with a software as a service (SaaS) application hosted by data management system 106 for managing and analyzing electronic data.

In one embodiment, in addition to data management system 106, end users of computing devices 102 also interact with one or more servers 108 to retrieve data used by data management system 106. The one or more servers 108 may store such data or may host an application that generates such data.

In one embodiment, data management system 106 generates a spreadsheet to manage and analyze electronic data. The spreadsheet implemented by data management system 106 allows for, among other things, document linking, user access control, tracking changes, and encryption. Advantageously, various combinations of such features work together to facilitate the management and analysis of data in a manner that is not possible by conventional systems.

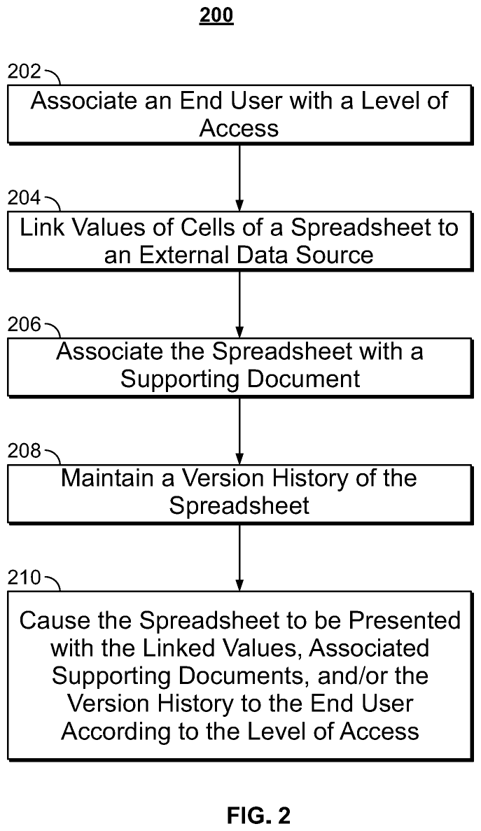

FIG. 2 shows a method 200 for managing and analyzing electronic data, in accordance with one embodiment. Method 200 will be described with respect to communications system 100 of FIG. 1. In one embodiment, the steps of method 200 are performed by data management system 106. It should be understood that the steps of method 200 may be performed in any order.

At step 202, an end user is associated with a level of access. Step 202 may be performed at any time in response to input received from an administrative user. The administrative user is any user that has authorization to define the level of access for the end user. In one embodiment, the level of access for the end user is defined as one of no access, read only access, and read/write access.

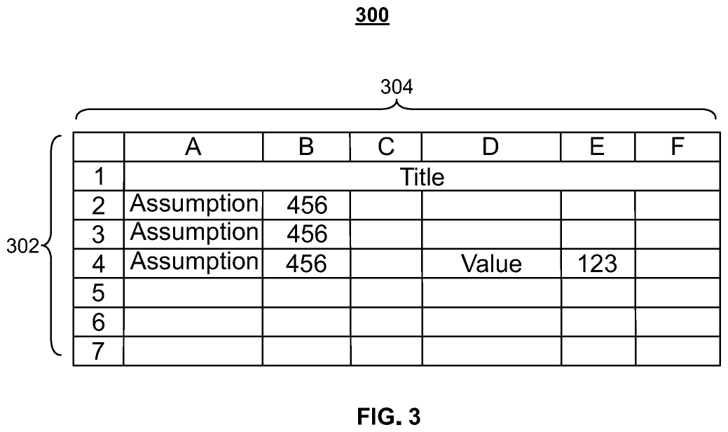

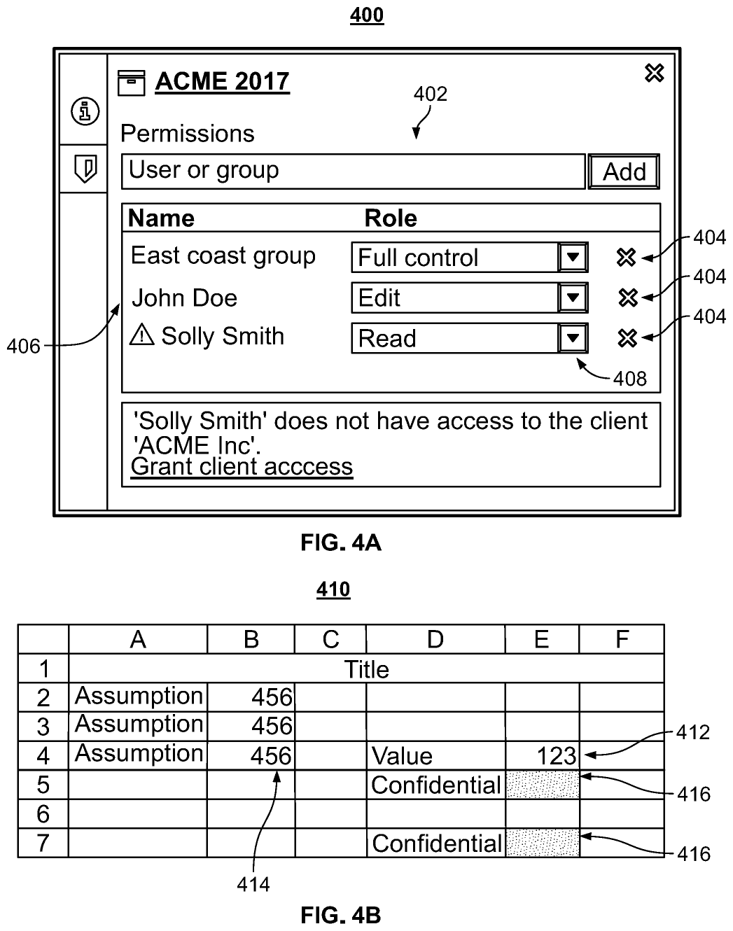

In one embodiment, the level of access associated with the end user is for accessing a spreadsheet, such as, e.g., spreadsheet 300 of FIG. 3. The spreadsheet may be stored in memory as data associated with cells of the spreadsheet. The level of access may be defined according to any level of granularity of the spreadsheet. For example, the level of access may be defined for the spreadsheet application, for the entire spreadsheet workbook (i.e., all spreadsheet tabs of the workbook), for one or more individual tabs of the workbook, for a group or range of cells of a tab, and/or for a particular cell of a tab. Associating a level of access to the end user for accessing a spreadsheet is described in further detail below with respect to FIGS. 4A-4B.

The spreadsheet may be securely stored in an encrypted database (e.g., an encrypted database of data management system 106). In one embodiment, the encrypted database may be encrypted with advanced encryption standard (AES)-256. The end user may access the spreadsheet using transport layer security (TLS) encryption to securely transfer documents to and from the encrypted database.

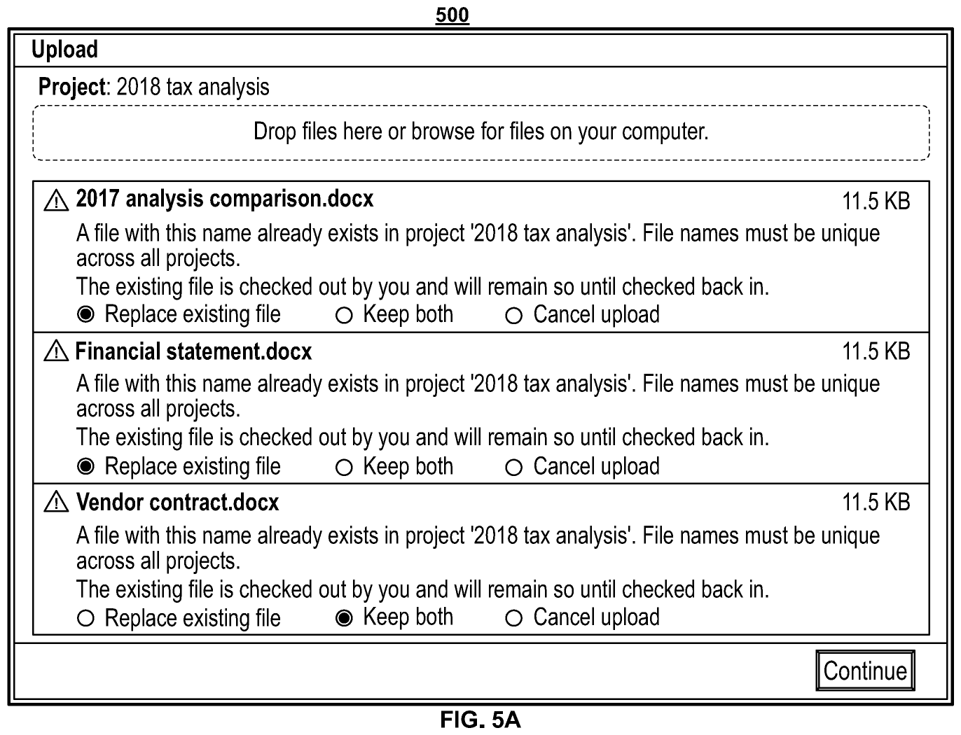

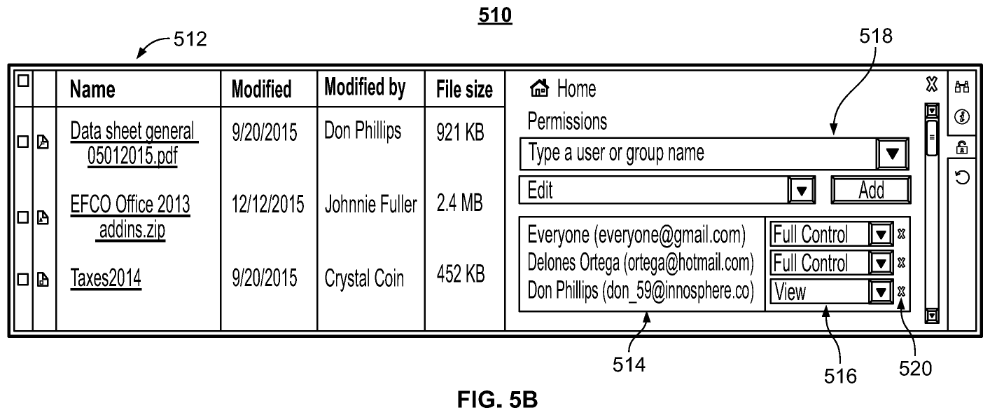

In one embodiment, the level of access associated with the end user is for accessing external source data and/or supporting documents. External source data refers to any source of data that is located external to the spreadsheet, such as, e.g., data generated or calculated by an application or data in a cell in a different spreadsheet. Supporting documents include any document supporting or relating to the data in the spreadsheet. Associating a level of access for accessing external source data and/or supporting documents is described in further detail below with respect to FIGS. 5A-5B.

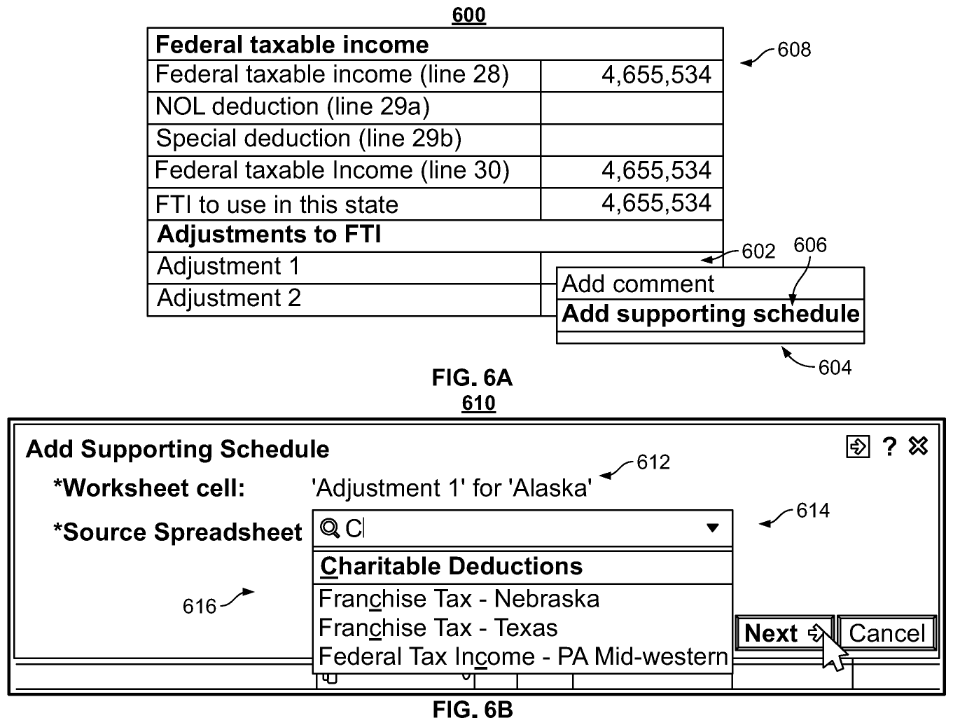

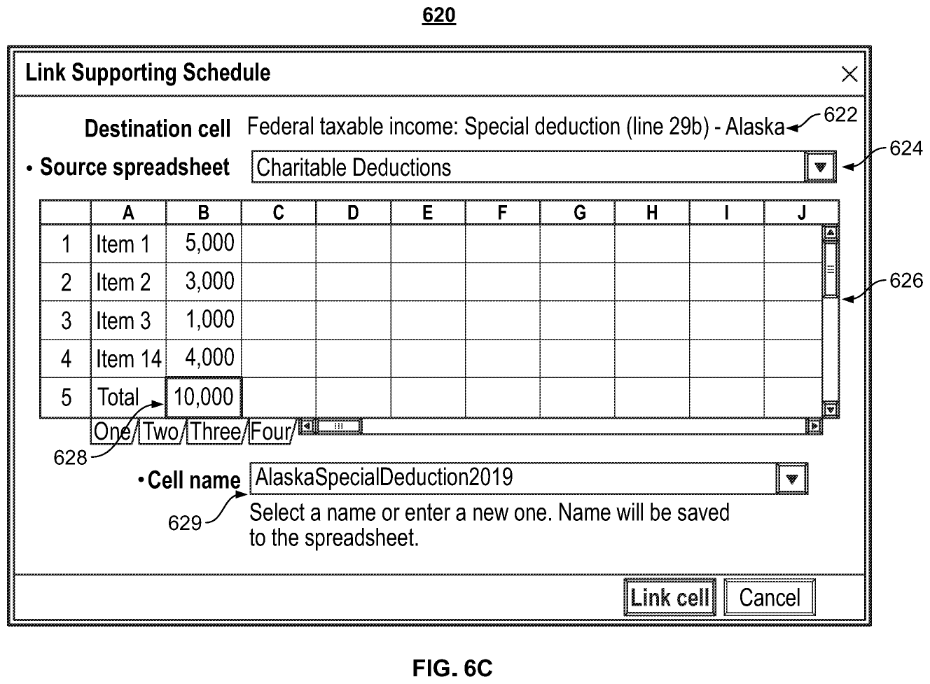

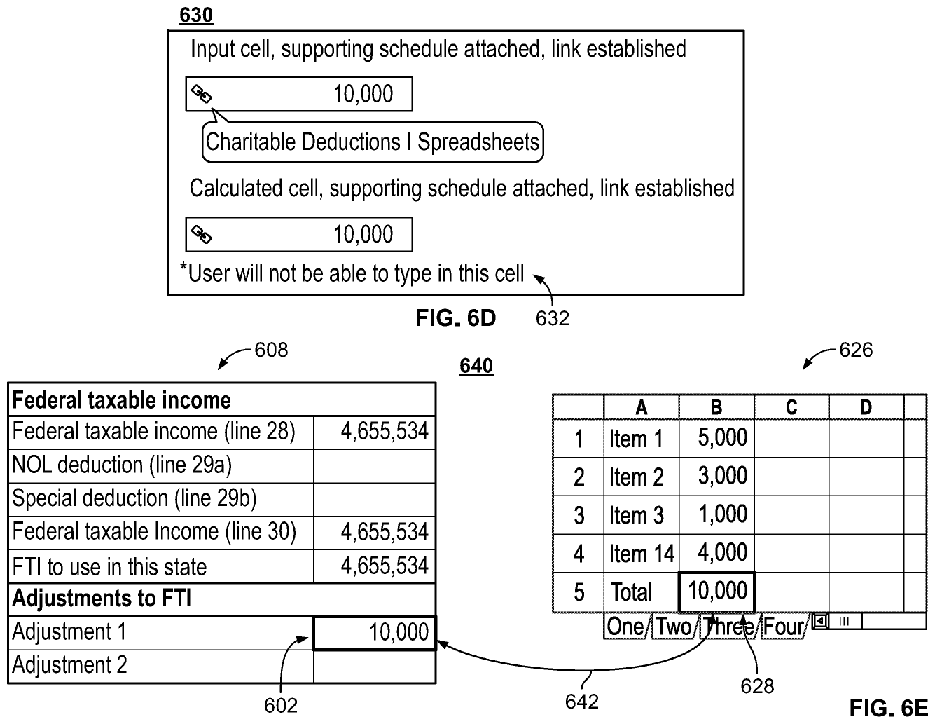

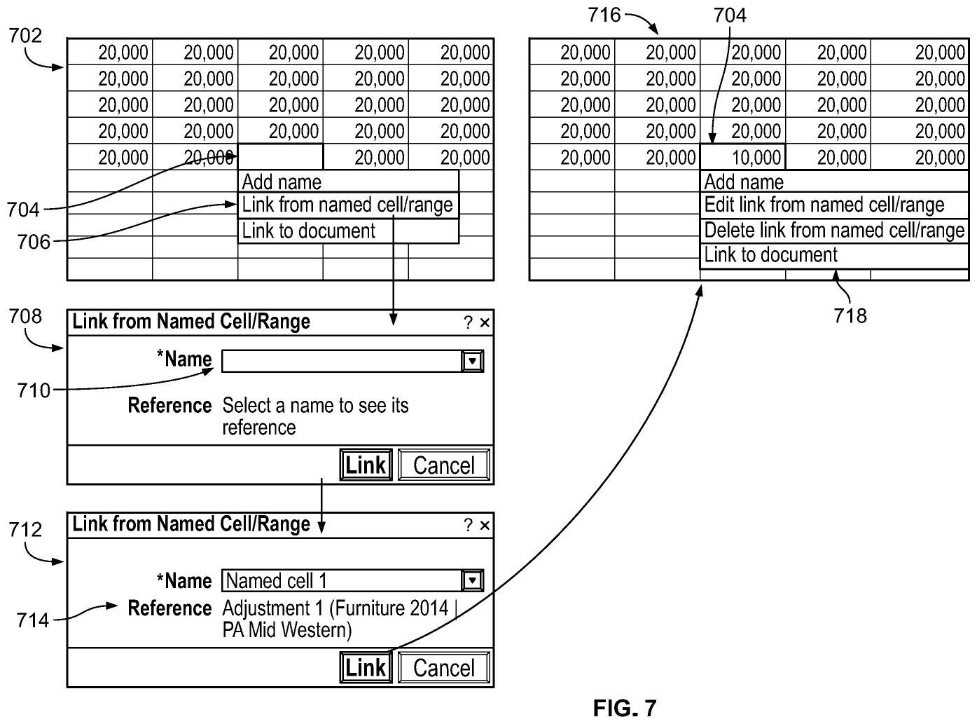

At step 204, values of cells of a spreadsheet are linked to external source data based on the level of access associated with the end user. The external source data may be selected by the end user from a set of available external source data that the end user is authorized to access according to the level of access. The values of the cells of the spreadsheet may be linked to external source data such that the values of the cells are pulled from and/or pushed to the values of the external source data. Linking values of cells of the spreadsheet to external source data is described in further detail below with respect to FIGS. 6A-6D and 7.

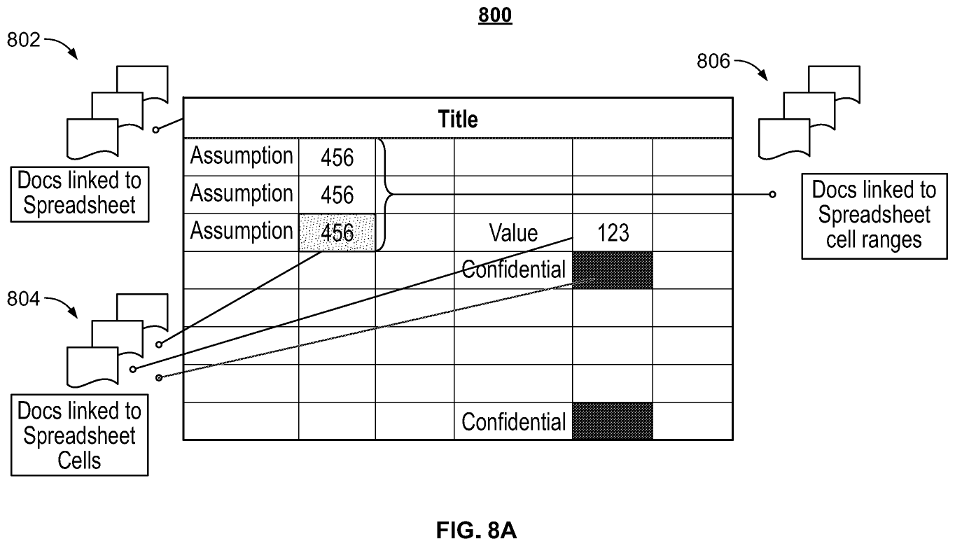

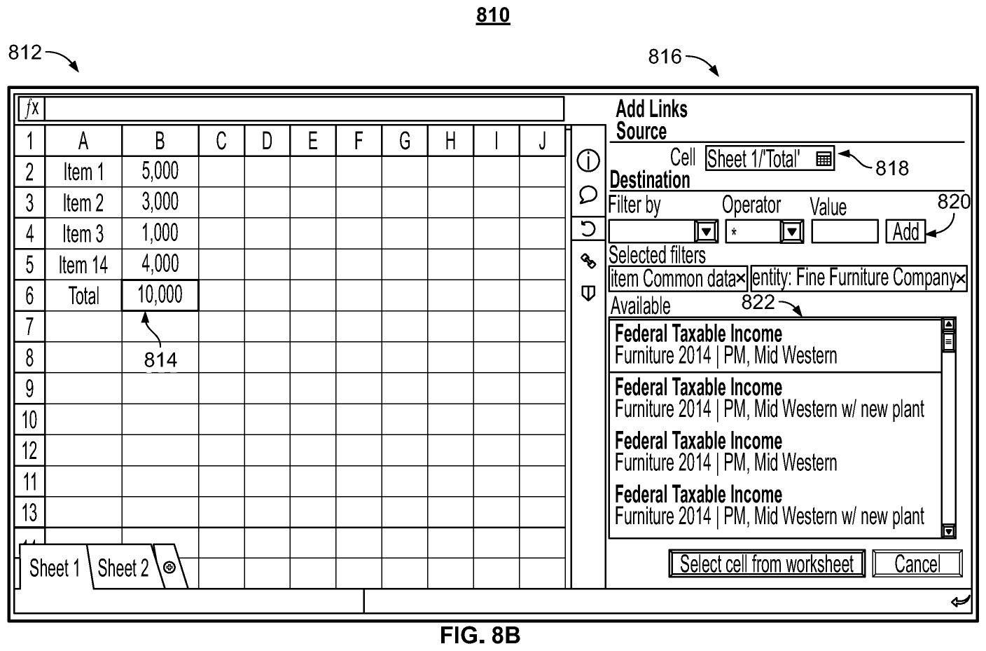

At step 206, the spreadsheet is associated with a supporting document based on the level of access associated with the end user. The supporting document may be in any suitable format (e.g., PDFs, text documents, photographs, and emails). The supporting document may be associated with the spreadsheet according to any level of granularity of the spreadsheet. For example, the supporting document may be associated with an entirety of the spreadsheet workbook, with one or more individual tabs of the workbook, with a group or range of cells of a tab, and/or with a particular cell of a tab. In one example, the supporting document is associated with a cell to support the value of the cell. The spreadsheet may be associated with the supporting document by selecting the supporting document from a set of available supporting documents that the end user is authorized to access according to the level of access. The end user may interact with the spreadsheet to view the supporting document. Associating the spreadsheet with a supporting document is described in further detail below with respect to FIGS. 8A-8B.

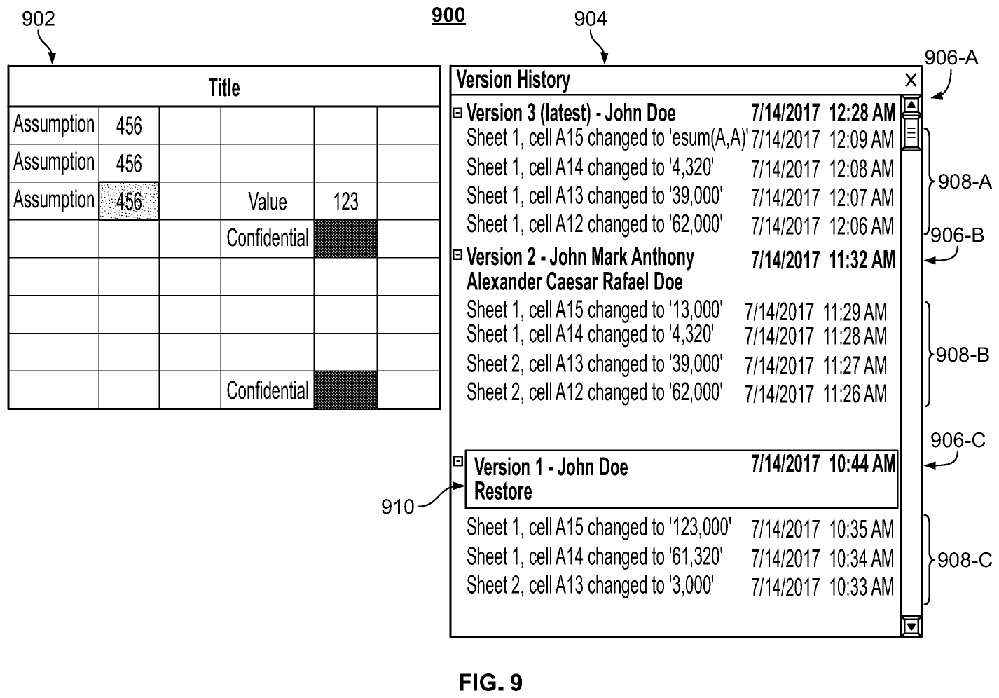

At step 208, a version history of the spreadsheet is maintained. The version history of the spreadsheet may include a number of versions of the spreadsheet, each associated with changes to the spreadsheet relative to its immediately prior version. Each version may be automatically generated (e.g., at predefined time intervals or upon the occurrence of an event) or manually generated in response to input from the end user. The version history of the spreadsheet is described in further detail below with respect to FIG. 9.

At step 210, the spreadsheet is caused to be presented with the linked values, associated supporting documents, and/or the version history to the end user according to the level of access. For example, the data associated with the cells of the spreadsheet, the linked values, and the version history may facilitate the presentation of the spreadsheet to the end user according to the level of access. In one embodiment, the spreadsheet is displayed with the version history on a display device of the end user (e.g., computing device 102). In one embodiment, particular changes associated with a version of the spreadsheet are caused to be presented to the end user, where the particular changes are changes that the end user is authorized to view according to the level of access.

FIG. 3 shows an illustrative spreadsheet 300 for managing and analyzing data, in accordance with one or more embodiments. Spreadsheet 300 may be the spreadsheet accessed by the end user at step 202 of FIG. 2. Spreadsheet 300 comprises cells in tabular form defined by the intersection of rows 302 and columns 304, labelled as rows 1 through 7 and columns A through F, respectively. The cells may store data, which may be received as user input from an end user (e.g., of computing device 102 of FIG. 1). The data may be stored in memory and associated with cells of the spreadsheet to thereby define the cells of the spreadsheet. In some embodiments, spreadsheet 300 may comprise a plurality of sheets or pages (not shown) each comprising a sub-spreadsheet.

FIG. 4A shows a user interface 400 for associating a level of access with an end user for accessing a spreadsheet, in accordance with one embodiment. The level of access associated with the end user may be defined by an administrative user. The level of access for accessing the spreadsheet may be defined according to any level of granularity of the spreadsheet, such as, e.g., for the spreadsheet application, for the entire spreadsheet workbook (i.e., all spreadsheet tabs of the workbook), for one or more individual tabs of the workbook, for a group or range of cells of a tab, and/or for a particular cell of a tab. An administrative user may interact with (e.g., a right-click mouse operation) the spreadsheet, a sheet of the spreadsheet, a group of cells of the spreadsheet, or the particular cell of the spreadsheet to open user interface 400 to define the level of access. The levels of access may include, for example, deny access (i.e., no access to read or write/edit), restricted access (i.e., read only access), or full access (i.e., read and write/edit access). The administrative user may also define security settings for the end user, such as, e.g., single sign on, two-factor authentication, and IP address restriction.

A level of access may be defined for each user or group of users in list 406 of users using menu 408 (e.g., a drop-down menu). Menu 408 may provide different options from which a level of access may be selected for users in list 406. New users or new groups of users may be added to list 406 using field 402. Users or groups of users may be removed from list 406 by interacting with (e.g., clicking) icon 404. As shown in user interface 400, the east coast group is associated with the level of access of full control, the end user John Doe is associated with the level of access of edit, and the end user Sally Smith is associated with the level of access of read. In one embodiment, to facilitate definition of the level of access, the administrative user may define the level of access by groups of end users, in addition to assigning the level of access to individual end users.

If the end user does not have access to the spreadsheet application, the spreadsheet application will not be visible to the end user. If the end user has access to the spreadsheet, but the level of access is: 1) restricted to deny access, the end user will not be able to open the spreadsheet file (i.e., the spreadsheet workbook); 2) restricted to read access, the end user will be able to open and view the spreadsheet file but will not be able to write/edit the contents; or 3) full access, the end user will be able to open, read, and edit the contents of the spreadsheet file. If the end user has access to the spreadsheet at the spreadsheet tab level, but the level of access is: 1) restricted to deny access, the end user will not be able to view the spreadsheet tab; 2) restricted to read access, the end user will be able to open and view the spreadsheet tab but will not be able to write/edit the contents; or 3) full access, the end user will be able to open, read, and edit the contents of the spreadsheet tab. If the end user has access to the spreadsheet at the cell or range of cell level, but the level of access is: 1) restricted to deny access, the end user will not be able to view the cell or range of cells; 2) restricted to read access, the end user will be able to view the cell or range of cells but will not be able to write/edit the contents of the cells; or 3) full access, the end user will be able to open, read, and edit the contents of the cell or range of cells.

FIG. 4B shows a spreadsheet 410 according to a level of access for an end user, in accordance with one embodiment. Spreadsheet 410 shows cells 416 for which the end user has no access. Accordingly, the data in cells 416 is redacted in spreadsheet 410. In one example, the end user is associated with a level of access of no access for cells storing sensitive and confidential information, such as confidential financial information, personal identifying information, etc. Spreadsheet 410 also includes cell 414 in which the end user has read only access. Cells in which the end user has read only access may or may not be visually distinguished from other cells in spreadsheet 410. For example, cell 414 is shown in italics in FIG. 4B to indicate that the end user has read only access. It should be understood that cell 414 may be represented according to any suitable visual representation (e.g., color or font) to indicate that the end user has read only access. Spreadsheet 410 also includes cell 412 in which the end user has full access.

FIG. 5A shows a user interface 500 for uploading supporting documents, in accordance with one embodiment. The supporting documents include any document supporting or relating to the data in the spreadsheet. The supporting documents may be stored locally (e.g., on data management system 106 of FIG. 1) or remotely (e.g., on one or more servers 108 of FIG. 1). The supporting documents may be associated with the spreadsheet, as discussed in further detail below with respect to FIGS. 8A-8B.

FIG. 5B shows a user interface 510 for associating a level of access with an end user for accessing external source data and/or supporting documents, in accordance with one embodiment. The external source data and/or supporting documents are shown in list 512 of user interface 510. End users or groups of end users in list 514 of end users are associated with a level of access using menu 516 (e.g., a drop-down menu). Menu 516 may provide different options from which a level of access may be selected for the users in list 514, such as, e.g., no access, view (i.e., read only access), or full control (i.e., read and write/edit access). The level of access associated with each end user in list 514 is applied to each supporting document selected in list 512. New users or new groups of users may be added to list 514 using field 518. Users or groups of users may be removed from list 514 by interacting with (e.g., clicking) icon 520.

FIG. 6A shows a user interface 600 for linking a value of a cell of a spreadsheet to external source data, in accordance with one embodiment. User interface 600 shows spreadsheet 608 for, e.g., analyzing federal taxable income. Spreadsheet 608 includes cell 602 having a value which is to be linked to external source data. The value of cell 602 may be linked to external source data such that the value of cell 602 is pulled from the value of the external source data (i.e., the value of cell 602 is updated to be the value of the external source data) and/or the value of cell 602 is pushed to the value of the external source data (i.e., the value of the external source data is updated to be the value of cell 602).

External source data refers to any source of data that is located external to spreadsheet 608. In one embodiment, the external source data is data generated or calculated by an application. The application may be hosted by one or more servers 108 of FIG. 1. In one embodiment, the application is a tax analysis application. In one embodiment, the application is the analysis engine disclosed in U.S. patent application Ser. No. 15/223,843, entitled “Data Analysis Engine,” which is herein incorporated by reference in its entirety. In another embodiment, the external source data is data of a supporting document. For example, the external source data may be a value of a cell in a spreadsheet. The supporting document may be a document uploaded via user interface 500 of FIG. 5A.

An end user may interact with spreadsheet 600 to link the value of cell 602 with the value of the external source data. In one embodiment, the end user interacts with cell 602 (e.g., a right-click mouse operation) to bring up a context menu 604. The end user selects option 606, “Add supporting schedule,” from context menu 604 to bring up a window (e.g., a pop-up window) where the end user may select the external source data.

FIG. 6B shows a window 610 where an end user may select a supporting document having the external source data for linking to cell 602 of FIG. 6A, in accordance with one embodiment. Window 610 may be a pop-up window that appears in response to selection of option 606 in FIG. 6A. Window 610 includes a field 612 identifying the name of cell 602, which may have been previously entered by the end user (or another user). Window 610 also includes a field 614 where the end user inputs the name of the supporting document (referred to as the source spreadsheet in FIG. 6B) and/or selects the name of the supporting document from drop-down menu 616.

In one embodiment, drop-down menu 616 displays supporting documents according to the level of access associated with the end user. The level of access associated with the end user for accessing the supporting documents may be defined as described above with respect to FIG. 5B. In one embodiment, drop-down menu 616 does not show particular supporting documents where the end user is not associated with a level of access giving the end user permission to view the particular source file.

FIG. 6C shows a window 620 where an end user may select external source data from a spreadsheet selected in field 614 in FIG. 6B to link to cell 602, in accordance with one embodiment. Window 620 may be a pop-up window that appears in response to selection of a spreadsheet (or another supporting document) in field 616 of window 610 in FIG. 6B. Window 620 includes a field 622 identifying the name of cell 602, which may have been previously entered by the end user (or another user). Window 620 also includes a drop-down menu 624 for selecting, or changing the selection of, supporting documents (e.g., spreadsheets). Drop-down menu 624 may display supporting documents according to the level of access associated with the end user. In response to a selection of a supporting document in drop-down menu 624, an embedded window 626 allowing the end user to visually see and interact with the selected supporting document is presented. The end user may select the external source data from the embedded window 626. For example, the end user may select cell 628 from embedded window 626 as the external source data. Alternatively, the end user may enter or select (e.g., from a drop-down menu) the name of cell 628 from field 629.

Once cell 628 is selected, the end user provides a name that is unique within that spreadsheet. The spreadsheet application creates a unique identifier associated with each named cell. To establish a link between cell 628 and cell 602, the spreadsheet application retrieves the unique identified associated with cell 628 and associates the identifier with the destination cell 602. Each time the spreadsheet is loaded, it calls out to the source spreadsheet to retrieve values of the cell 628.

FIG. 6D shows a window 630 confirming a link between cell 602 and cell 628, in accordance with one embodiment. The cell 628 may have been selected by the end user from window 620 in FIG. 6C. Window 630 includes a notification 632 that the user will not be able to type in cell 602. Accordingly, cell 602 only pulls data from the Charitable Deductions spreadsheet and does not push data to the Charitable Deductions spreadsheet.

FIG. 6E illustratively depicts an overview 640 of a link between cell 602 of spreadsheet 608 and cell 628 of spreadsheet 626, in accordance with one embodiment. A value of cell 602 is pulled or retrieved from the value (i.e., 10,000) of cell 682, as illustrated by link 642.

FIG. 7 shows another embodiment for linking a cell to external source data that is named. An end user may interact with cell 704 of a spreadsheet shown in window 702 to link the value of cell 704 to external source data. In one embodiment, the end user interacts with cell 704 to launch context menu 706 and selects the option to link from a named cell/range. In response, window 708 is presented where the end user enters the name of the external source data (e.g., the name of a cell associated with a spreadsheet) and/or selects the name of the external source data from a drop-down menu (not shown in FIG. 7). The name of the external source data may have been previously assigned by the end user (or another user). In response to the selection of the external source data, a window 712 shows reference information 714 for the selected external source data. In one embodiment, reference information 714 includes the name of the supporting document in which the external source data is located. For example, reference information 714 in window 712 shows the name of a spreadsheet, “Adjustment 1 (Furniture 2014|PA Mid Western),” where the selected cell, “Named cell 1,” is located. Window 716 shows cell 704 having a value 10,000, which is the value of the cell “Named cell 1.” The end user can interact with cell 704 to, e.g., edit and/or remove the link to “Named cell 1.”

FIG. 8A shows an illustrative spreadsheet 800. Spreadsheet 800 may be associated or linked with electronic supporting documents, which may be in any suitable format, such as, e.g., PDFs, text documents, photographs, and emails. FIG. 8A shows documents 802 associated with the entire spreadsheet 800, documents 804 associated with particular cells of spreadsheet 800, and documents 806 associated with a range or group of cells of spreadsheet 800. An end user may interact with spreadsheet 800 and/or cells of spreadsheet 800 to view the associated documents.

FIG. 8B shows a user interface 810 for associating a cell 814 of spreadsheet 812 with supporting documents, in accordance with one embodiment. An end user may interact with cell 814 to open a menu 816. For example, the end user may perform a right-click mouse operation on cell 814 to open a context menu and select an option in the context menu for linking the cell to a supporting document. In one embodiment, the context menu may be context menu 718 shown in FIG. 7. Menu 816 includes a source field 818 for identifying the cell that the supporting document is to be associated with (e.g., cell 814 in spreadsheet 812). Source field 818 may automatically populate with information identifying cell 814 based on the end user's interaction with cell 814. The end user may select one or more supporting documents to associate cell 814 with from a list 822 of available documents. The list 822 of available documents may represent available documents satisfying a filter criteria input by the end user in field 820. In one embodiment, the list 822 of available documents may show available documents in accordance with the level of access associated with the end user. In one embodiment, the list 822 of available documents does not include particular supporting documents where the end user is not associated with a level of access giving the end user permission to view the particular supporting documents.

FIG. 9 shows a user interface 900 showing a version history of a spreadsheet, in accordance with one embodiment. A version history of spreadsheet 902 is maintained, e.g., by data management system 106 of FIG. 1. An end user may interact with spreadsheet 902 (e.g., by selecting an option in a menu) to view version history interface 904. Spreadsheet 902 is associated with version 1 906-A, version 2 906-B, and version 3 906-C (collectively referred to as versions 906), as shown in version history interface 904. Versions 906 may be automatically generated (e.g., at predefined time intervals or upon the occurrence of an event) or may be manually generated in response to user input from the end user.

Each of version 1 906-A, version 2 906-B, and version 3 906-C is associated with changes 908-A, 908-B, and 908-C (collectively referred to as changes 908), respectively, and shown in version history interface 904. The changes 908 associated with each version 906 are determined by comparing spreadsheet 902 with the spreadsheet associated with the immediately prior version. For example, changes 908-A associated with version 906-A are determined by comparing the current spreadsheet 902 with the spreadsheet associated with version 906-B. Changes 908 include information on what was changed, by whom, and when (date and time). Changes 908 may also track when a user imports (e.g., checks-in) and exports (e.g., checks-out) spreadsheet 902. In one embodiment, changes 908 are shown in accordance with a level of access associated with the end user. For example, changes 908 may not show particular changes where the end user is not associated with a level of access giving the end user permission to view the cell associated with the particular changes. The end user may restore spreadsheet 902 to a particular version using the version history interface 904. In one example, an end user may select version 906-C and select option 910 to restore spreadsheet 902.

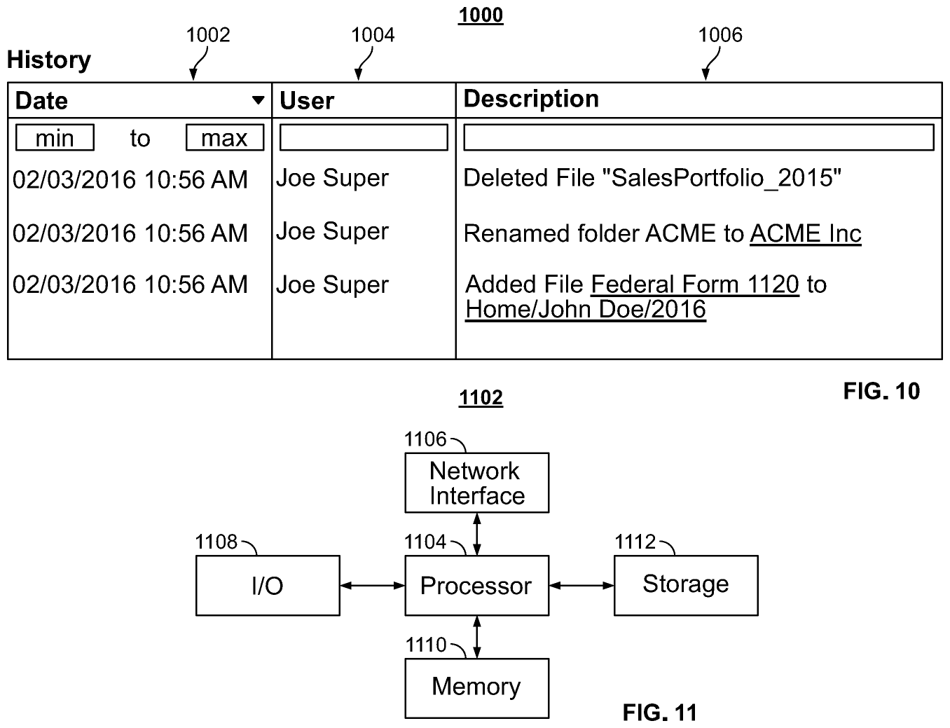

FIG. 10 shows a user interface 1000 for viewing access history of documents, in accordance with one or more embodiments. User interface 1000 may show access history of a spreadsheet or other supporting documents, such as, e.g., the documents uploaded via user interface 500 of FIG. 5A. The access history of the documents may be maintained by data management system 106 of FIG. 1. The access history of a document may include a description 1006 of the access to the document (e.g., read or write), a time and date 1002 of access to the document, and the end user 1004 who accessed the document. Advantageously, the access history of a document may be used to generate an audit report to show the chain of control such that an auditor, court, or other authority can verify the integrity of a process that is important and subject to control.

Consider an exemplary use scenario of the present invention, in accordance with one embodiment. A corporation needs to prepare for its quarterly financial reporting disclosures required under SEC (Securities and Exchange Commission) regulations for publicly traded companies. The tax department of the company has several spreadsheets that are used for important and confidential aspects of their potential tax obligations that are considered material to their financial reporting process. The first spreadsheet relates to calculations around foreign tax credits and repatriation. The second spreadsheet relates to confidential litigation where a potential settlement is under negotiation. The negotiation is not public, and knowledge of the negotiation could impact the stock price for the company and the plaintiff's company. The third spreadsheet relates to the overall uncertain tax positions of the corporation that will be summarized for business. This spreadsheet includes information about a possible acquisition that is not public that may or may not close within the reporting period.

Each of the spreadsheets contains confidential information that needs to be protected not only from public view but also from those within the company that do not have a need-to-know. Applying embodiments of the present invention, the company could set permissions on who can view each spreadsheet to allow for pertinent data from each spreadsheet to be shared with other users who do not have full authorization to see the entire spreadsheet. This includes the ability to share specific cells and ranges of cells with users that do not have authorization to view an entire spreadsheet, similar to redaction of a document with confidential information. For example, a user may request another user to populate a spreadsheet with data necessary for performing calculations, such as for compiling financial statement data or tax return data. The user can grant permissions (i.e., a level of access) only to specific cells or sheets so that the other user is only able to update and/or see the area of the spreadsheet designated specifically to him or her.

All changes made to these spreadsheets are tracked throughout the history of each spreadsheet, and the history cannot be edited by a user. The spreadsheets can then be reviewed and signed off on, tracking that proper sign off procedures have taken place.

Systems, apparatuses, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be implemented within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIG. 2. Certain steps of the methods described herein, including one or more of the steps of FIG. 2, may be performed by a server or by another processor in a network-based cloud-computing system. Certain steps of the methods described herein, including one or more of the steps of FIG. 2, may be performed by a client computer in a network-based cloud computing system. The steps of the methods described herein, including one or more of the steps of FIG. 2, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIG. 2, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A high-level block diagram 1100 of an example computer that may be used to implement systems, apparatus, and methods described herein is depicted in FIG. 11. Computer 1102 includes a processor 1104 operatively coupled to a data storage device 1112 and a memory 1110. Processor 1104 controls the overall operation of computer 1102 by executing computer program instructions that define such operations. The computer program instructions may be stored in data storage device 1112, or other computer readable medium, and loaded into memory 1110 when execution of the computer program instructions is desired. Thus, the method steps of FIG. 2 can be defined by the computer program instructions stored in memory 1110 and/or data storage device 1112 and controlled by processor 1104 executing the computer program instructions. For example, the computer program instructions can be implemented as computer executable code programmed by one skilled in the art to perform the method steps of FIG. 2. Accordingly, by executing the computer program instructions, the processor 1104 executes the method steps of FIG. 2. Computer 1102 may also include one or more network interfaces 1106 for communicating with other devices via a network. Computer 1102 may also include one or more input/output devices 908 that enable user interaction with computer 1102 (e.g., display, keyboard, mouse, speakers, buttons, etc.).

Processor 1104 may include both general and special purpose microprocessors, and may be the sole processor or one of multiple processors of computer 1102. Processor 1104 may include one or more central processing units (CPUs), for example. Processor 1104, data storage device 1112, and/or memory 1110 may include, be supplemented by, or incorporated in, one or more application-specific integrated circuits (ASICs) and/or one or more field programmable gate arrays (FPGAs).

Data storage device 1112 and memory 1110 each include a tangible non-transitory computer readable storage medium. Data storage device 1112, and memory 1110, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 1108 may include peripherals, such as a printer, scanner, display screen, etc. For example, input/output devices 1108 may include a display device such as a cathode ray tube (CRT) or liquid crystal display (LCD) monitor for displaying information to the user, a keyboard, and a pointing device such as a mouse or a trackball by which the user can provide input to computer 1102.

Any or all of the systems and apparatus discussed herein, including computing devices 102, data management system 106, and servers 108 of FIG. 1, may be implemented using one or more computers such as computer 1102.

One skilled in the art will recognize that an implementation of an actual computer or computer system may have other structures and may contain other components as well, and that FIG. 11 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for managing data comprising:
associating an end user with a level of access;
linking values of cells of a spreadsheet to external source data, the external source data selected by the end user from a set of available external source data according to the level of access;
maintaining a version history of the spreadsheet; and
causing the spreadsheet to be presented with the linked values and the version history to the end user according to the level of access.

2. The method of claim 1, further comprising:
associating the spreadsheet with a supporting document according to the level of access.

3. The method of claim 2, wherein associating the spreadsheet with a supporting document comprises:
associating one of a workbook of the spreadsheet, a tab of the workbook, a group of cells of the tab, and a particular cell of the tab with the supporting document.

4. The method of claim 2, wherein associating the spreadsheet with a supporting document comprises:
selecting the supporting document from a set of available supporting documents that the end user is authorized to access according to the level of access.

5. The method of claim 1, wherein the external source data comprises a cell of another spreadsheet.

6. The method of claim 1, wherein the external source data comprises data generated by an application.

7. The method of claim 1, wherein associating an end user with a level of access comprises:
defining the level of access for one of a workbook of the spreadsheet, a tab of the workbook, a group of cells of the tab, and a particular cell of the tab for the end user.

8. The method of claim 1, wherein causing the spreadsheet to be presented with the linked values and the version history to the end user according to the level of access comprises:
causing particular changes associated with a version of the spreadsheet to be presented to the end user, the particular changes being changes that the end user is authorized to view according to the level of access.

9. The method of claim 1, further comprising:
storing the spreadsheet in an encrypted database.

10. A non-transitory computer readable medium storing computer program instructions for managing data, which, when executed on a processor, cause the processor to perform operations comprising:
associating an end user with a level of access;
linking values of cells of a spreadsheet to external source data, the external source data selected by the end user from a set of available external source data according to the level of access;
maintaining a version history of the spreadsheet; and
causing the spreadsheet to be presented with the linked values and the version history to the end user according to the level of access.

11. The non-transitory computer readable medium of claim 10, the operations further comprising:
associating the spreadsheet with a supporting document according to the level of access.

12. The non-transitory computer readable medium of claim 11, wherein associating the spreadsheet with a supporting document comprises:
associating one of a workbook of the spreadsheet, a tab of the workbook, a group of cells of the tab, and a particular cell of the tab with the supporting document.

13. The non-transitory computer readable medium of claim 11, wherein associating the spreadsheet with a supporting document comprises:
selecting the supporting document from a set of available supporting documents that the end user is authorized to access according to the level of access.

14. The non-transitory computer readable medium of claim 10, wherein the external source data comprises a cell of another spreadsheet.

15. The non-transitory computer readable medium of claim 10, wherein the external source data comprises data generated by an application.

16. An apparatus comprising:
a processor; and
a memory to store computer program instructions, the computer program instructions when executed on the processor cause the processor to perform operations comprising:
associating an end user with a level of access;
linking values of cells of a spreadsheet to external source data, the external source data selected by the end user from a set of available external source data according to the level of access;
maintaining a version history of the spreadsheet; and
causing the spreadsheet to be presented with the linked values and the version history to the end user according to the level of access.

17. The apparatus of claim 16, the operations further comprising:
associating the spreadsheet with a supporting document according to the level of access.

18. The apparatus of claim 16, wherein associating an end user with a level of access comprises:
defining the level of access for one of a workbook of the spreadsheet, a tab of the workbook, a group of cells of the tab, and a particular cell of the tab for the end user.

19. The apparatus of claim 16, wherein causing the spreadsheet to be presented with the linked values and the version history to the end user according to the level of access comprises:
causing particular changes associated with a version of the spreadsheet to be presented to the end user, the particular changes being changes that the end user is authorized to view according to the level of access.

20. The apparatus of claim 16, the operations further comprising:
storing the spreadsheet in an encrypted database.

21. A non-transitory computer readable medium storing:
data associated with cells of a spreadsheet;
links associating values of particular cells of the spreadsheet with external source data, the external source data selected by an end user from a set of available external source data according to a level of access associated with the end user; and
a version history of the spreadsheet;
wherein the data, the links, and the version history facilitate presentation of the spreadsheet to the end user according to the level of access.
